(19) United States
(12) Patent Application Publication
(10) Pub. No.: US 2007/0237605 A1
(43) Pub. Date: Oct. 11, 2007

(54) Pin

(75) Inventors: Doug Duncan, Sunderland (GB); Peter Holland, Gateshead (GB); Arthur Hodgen, Nurton Seaham (GB)

Correspondence Address: Thomas E. Sisson;Jackson Walker, LLP, Suite 2100, 112 E. Pecan, San Antonio, TX, 78205, US

(73) Assignee: Northern Hydraulic Cylinder Engineers Limited

(21) Appl. No.: 11/249,582

(22) Filed: Oct. 13, 2005

(51) Int. Cl. F16B 21/00

(52) U.S. Cl. 411/351

(57) ABSTRACT

A pin comprises an inner element and an outer sleeve. The inner element is insertable into and removable from the outer sleeve, and the outer surface of the inner element and the inner surface of the outer sleeve are tapered along at least a part of their lengths.

### FIELD OF THE INVENTION

The present invention relates to pins and in particular to pins that mount equipment that must be removed from time to time.

### BACKGROUND OF THE INVENTION

Pins are often used to mount elements of equipment which must be removed from time to time. For example there are many applications in the oil and gas industry where pins are used to mount hydraulic cylinders. Hydraulic cylinders must be serviced regularly in order for them to perform reliably.

Where machines are used in harsh conditions they suffer from corrosion. It is often the case that due to corrosion pins are difficult to remove when they have been in service for only a modest period. In the off-shore oil and gas industry it is common practice for hydraulic cylinders to be removed from service and taken away for repair. Typically, hydraulic cylinders are removed every six years. Off-shore oil rigs are exposed to the most extreme environments, and it is common for pins to be so corroded that a machine such as an oxy-acetylene torch, spark eroder, hydraulic press or in line borer is required to remove the pin. In most areas of off-shore oil/gas rigs health and safety regulations forbid the use of equipment generating in excess of 240 C. As such, normal practice is for pins to be pressed or bored out. The equipment required for either pressing or boring out a pin is substantial, requiring transport to and from the rig by vessel and a team of four men for its operation who would be transported by helicopter.

The requirement to bring in specialist equipment to remove a pin is not desirable. It is expensive in terms of manpower, equipment requirements and plant downtime (for example when a pin must be removed at a non-scheduled time).

An example of a device for removing pins that have been working in harsh environments can be found in U.S. Pat. No. 4,870,739 which describes a device for forcing the pins out of links in chains that have been used to secure anchors or buoys.

As well as being a problem in the oil and gas and marine industries, corrosion of pins is a problem in other areas. For example in the construction and agricultural industries machines work outside and are subjected to dust, debris, extremes of temperature, rain, etc, all resulting in corrosion. In the chemical industries elements of machines may be located in environments which cause corrosion.

It would therefore be desirable to provide an improved pin.

### SUMMARY OF THE INVENTION

According to one aspect of the invention there is provided a pin as specified in Claim 1.

According to another aspect of the invention there is provided mounting arrangement as specified in Claim 14.

According to another aspect of the invention there is provided a method of mounting an object as specified in Claim 15.

The pin of the invention provides for much easier removal of parts of machines secured in position by pins. Using the pin of the invention the job of removing a hydraulic cylinder (or other part) becomes a one man job requiring only a spanner and a grease gun or a hammer and chisel, instead of being a four man job requiring specialist equipment that must be transported to the site.

Releasing the pin of the invention does not require heat making the pin particularly suitable for use on oil and gas installations. In fact, the pin of the invention will find application in any scenario involving uncoated pins used in harsh environments.

### BRIEF DESCRIPTION OF THE DRAWINGS

In the drawings, which illustrate a preferred embodiment of the invention, and are by way of example:

FIG. 1 is a schematic representation of a pin according to the invention;

FIG. 2 is a cross-sectional elevation of the pin illustrated in FIG. 1;

FIG. 3a is a side view of a mounting arrangement according to the invention; and

FIG. 3b is a plan view of the mounting arrangement illustrated in FIG. 3a.

### DETAILED DESCRIPTION OF THE PREFERRED EMBODIMENTS

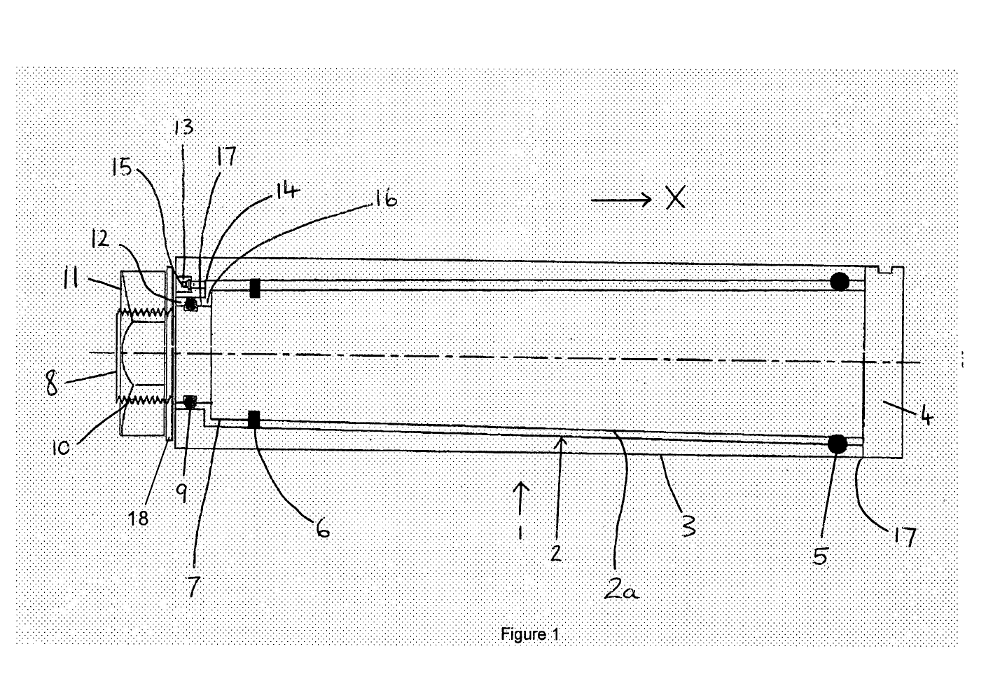

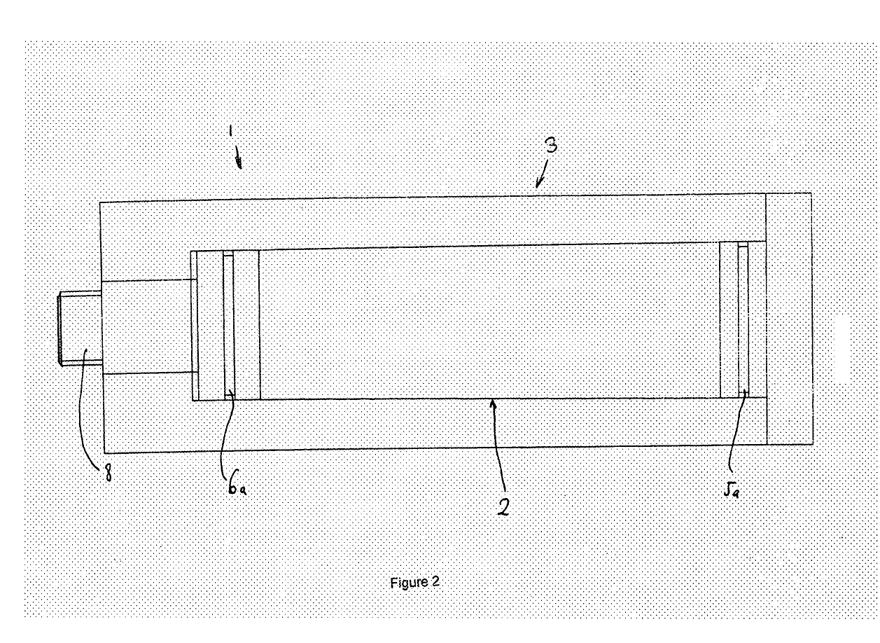

Referring now to FIGS. 1 and 2, there is shown a pin 1 comprising an inner element 2 having a first end 4 and a second end 4a and an elongate portion 2a extending between the said first and second ends. The elongate portion 2a is tapered between the first and second ends 4, 4a, the cross-section of the portion 2a being greater at the first end 4 than at the second 4a. A seal 5 adjacent the first end 4 sits in a seal housing 5a. The taper terminates at a seal 6 located in a seal housing 6a, the second end 4a including portion 7 having parallel sides. The second end 4a further includes a stub 8 including a threaded portion 10. A seal 9 is mounted on the stub 8.

The inner element 2 is housed in a sleeve 3, the inner element 2 and the sleeve 3 forming a substantially cylindrical pin, the external diameter of the sleeve 3 being substantially the same as the external diameter of the first end 4 of the inner element 2.

The sleeve 3 includes an opening 12 through which the stub 8 passes, the threaded portion 10 extending beyond the outer end of the sleeve 3. A seal 9 sits in a seal housing 9a in the form of a groove in the sleeve 3. An internally threaded nut 11 is fastened onto the threaded portion 10 of the stub 8 to secure together the inner element 2 and the sleeve 3 to form the pin 1.

The stub 8 may be unthreaded and lockable cap screws used to hold the inner element 2 in place.

The end wall of the sleeve 3 includes a bore 13 of a first diameter and extending therefrom a second bore that communicates with the chamber formed between the inner surface of the sleeve 3 and the outer surface of the parallel sided portion of the elongate element 2. The second bore is threaded, in use receiving either grub screw 15 which covers the grease nipple 14, the function of which is described in greater detail below.

To remove the pin 1, first the lock nut 11 is slackened and removed, then the grub screw 15 is removed allowing access to the grease nipple 14. A grease gun is attached to the grease nipple and is operated to force grease into the cavity 16. The cavity 16 is bounded by a face of the ‘O’ ring 9, the internal surface 17 of the sleeve 3, the outer surface 7 of the inner element 2 and one face of the seal 6. The build up of pressurised grease in the cavity 16 causes the inner element to move in the direction X. Due to the taper of the elongate section 2a and the inner surface of the sleeve 3, a relatively small amount of movement of the inner element 2 in the direction X results in the two parts of the pin being free of each other.

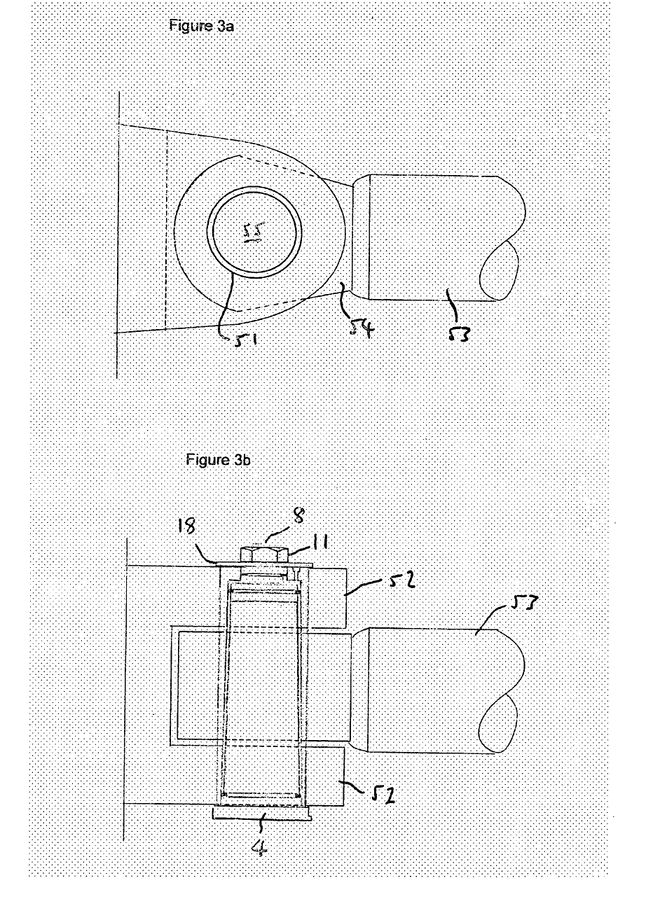

Referring now to FIGS. 3a and 3b, a mounting arrangement comprises a levis 50 including bores 51 in each of the bifurcations 52 of levis 50. A piston rod 53 of a hydraulic cylinder terminates in a bracket 54 including a bore 55. The pin 1 passes through aligned bores 51 and 55 and the lock nut 11 is fastened onto the threaded portion 10 of the stub 8. A lip 17 of the end 4 engages with the outer surface of one of the bifurcations 52 and the lock nut 11 engages with a washer 18, which may be a spring washer or an unsprung washer, to secure the pin 1 in a working position.

The method of assembling the arrangement illustrated in FIG. 3 comprises the steps of:
i) aligning the bores 51, 55;
ii) removing the lock nut 11 from a pin 1 as illustrated in FIG. 1;
iii) passing the pin 1 through the bores 51, 55;
iv) presenting a washer 18 up to an outer face of one of the bifurcations 52 over the stub 8; and
v) fastening lock nut 11 onto the stub 8 and tightening the same.

The method of disassembling the arrangement illustrated in FIG. 3 comprises the steps of:
i) slackening off the lock nut 11;
ii) removing the washer 18;
iii) removing the grub screw 15;
iv) attaching a grease gun to the grease nipple 14;
v) filling the cavity 16 with grease until the inner element 18 is force sufficiently far in the X direction to release the inner element 2 from the sleeve 3;
vi) removing the inner element 2 from the sleeve 3;
vii) removing the sleeve 3 or the remains thereof from the aligned bores 51, 55.

Where the mounting arrangement illustrated in FIGS. 3a and 3b has been located in a very harsh environment, such as an off-shore oil rig, the corrosion of the sleeve is usually such that when the inner element 2 is released the sleeve collapses, allowing the bracket 54 of piston rod 53 to be removed.

In a simplified embodiment of the invention instead of using a hydraulic system to separate the inner element from the sleeve a hammer, or hammer and chisel are employed. A fitter removes the lock nut 11 and taps on the end of the stub 8 with a hammer, or hammer and chisel. In such an embodiment there is no need for the seals 5, 6 and 9.

What I claim is:

1. A pin comprising an inner element and an outer sleeve, the inner element being insertable into and removable from the outer sleeve, wherein the inner element has an outer surface and the outer sleeve has an inner surface, and wherein the outer surface of the inner element and the inner surface of the outer sleeve are each tapered along at least a part of their lengths.

2. A pin according to claim 1, wherein one end of the outer sleeve is provided with a bore and one end of the inner element is provided with a stub, the stub projecting through the bore, the stub including at least a part of a fastening means, which in use, restricts movement of the inner element with respect to the outer sleeve.

3. A pin according to claim 2, wherein the stub is provided with an externally threaded portion, which co-operates with an internally threaded nut to form the fastening means.

4. A pin according to claim 1, wherein the inner element comprises at one end thereof a stop engagable with the outer sleeve to limit axial movement of the inner element with respect to the outer sleeve.

5. A pin according to claim 1, wherein along a part of the length of the outer sleeve the walls of the inner surface are parallel.

6. A pin according to claim 1, further comprising a bore in one end of the sleeve allowing the introduction of fluid into a cavity formed by the inner surface of the outer sleeve and the outer surface of the inner element.

7. A pin according to claim 6, further comprising a grease nipple located in said bore.

8. A pin according to claim 6, further comprising a closing member for closing off the said bore.

9. A pin according to claim 2, further comprising a seal located between the outer surface of the said stub and the inner surface of the said bore.

10. A pin according to claim 1, further comprising a seal between the outer surface of the inner element and the inner surface of the outer sleeve located in the region where the said outer and inner surfaces are tapered.

11. A pin according to claim 1, further comprising a seal between the outer surface of the inner element and the inner surface of the outer sleeve located in the region where the said outer and inner surfaces are parallel.

12. A pin according to claim 1, further comprising at least one end of the pin an element projecting radially outwardly of the outer surface of the outer sleeve.

13. A mounting arrangement comprising a structure, an element for attachment to the structure, and a pin as claimed in claim 1, wherein the element and the structure each comprise mounting elements comprising a bore and wherein the pin passes through the aligned bores attaching the element to the structure.

14. A method of assembling a mounting arrangement as claimed in claim 13 comprising the steps of
i) aligning the said bores;
removing fastening means from the inner element from the pin as claimed in claim 1;
iii) passing the pin through the bores;
iv) securing the fastening means to prevent axial movement of the pin in the bores.

15. A method of disassembling a mounting arrangement as claimed in claim 13, comprising the steps of:
i) releasing the fastening means;
ii) applying a force to the inner element of the pin to move the said element axially with respect to the outer sleeve;
iii) removing the inner element from the outer sleeve;
iv) removing the inner element or remains thereof from the bores.

16. A method according to claim 15, wherein the said force is generated by fluid pressure.

17. A method according to claim 16, wherein the fluid pressure is generated by attaching a grease gun to a grease nipple located on the pin and introducing grease into a cavity between the inner surface of the outer sleeve and the outer surface of the inner element.
